(19) United States
(12) Patent Application Publication
(10) Pub. No.: US 2012/0091293 A1
(43) Pub. Date: Apr. 19, 2012

(54) FASTENING DEVICE FOR A CABLE

(75) Inventor: Kenichi Ninomiya, Ludwigsburg (DE)

(73) Assignee: Robert Bosch GmbH, Stuttgart (DE)

(21) Appl. No.: 13/263,019

(22) PCT Filed: Mar. 15, 2010
(86) PCT No.: PCT/EP2010/053285

§ 371 Date: Dec. 23, 2011

(30) Foreign Application Priority Data
Apr. 6, 2009 (DE) 10 2009 002 197.3

(51) Int. Cl. F16L 3/12

(52) U.S. Cl. 248/74.2

(57) ABSTRACT

A fastening device for a cable, in particular for an electrical cable in a motor vehicle, includes a sleeve that can be retained in a holder and surrounds the cable at least partially in the axial direction. The sleeve is fastened releasably by way of a contour in a receiving opening of the holder. The sleeve has at least one guiding piece for installing the sleeve in the receiving opening in the correct position. Further, a mechanism is provided to increase the flexibility of the guiding piece.

### PRIOR ART

The invention is based on a fastening device for a line of the generic type described in the independent claim. DE 10 2006 042 663 A1 has already disclosed a fastening device of this kind which has a grommet which can be clamped in a holder, surrounds the line at least partially and is composed of elastically deformable material which is detachably fastened in a cutout in the holder by means of a contour. The surface of a grommet which is injection-molded from plastic is of segmented design for the purpose of achieving easier deformability of the grommet when installing said grommet in an associated holder.

The object of the present invention is to specify a fastening device which is distinguished by particularly simple installation in the correct position. This object is achieved by the features of the independent claim.

### ADVANTAGES OF THE INVENTION

The fastening device for a cable according to the invention is distinguished from the above in that, firstly, installation in the correct position is ensured by providing a guide part. It is also ensured that the fastening device can be easily installed in a receiving opening since means for increasing the flexibility of the guide part are provided. By way of example, a recess in the material is suitable for this purpose. Said recess in the material is preferably arranged perpendicular to the installation direction of the fastening device, and therefore, in particular, it is easier for the guide part to move in the axial cable direction. Therefore, the fastening device can be inserted into the receiving opening more effectively.

In one expedient development, provision is made for the fastening device to have at least one rotation-inhibiting section. This section suppresses a rotary movement of the fastening device about the cable axis in the receiving opening, and therefore disruptive twisting of the cable is prevented. To this end, the contour, which otherwise runs in a circular manner and which is detachably fastened in a receiving opening, is interrupted by sections which are not rotationally symmetrical. These preferably interact with a constricted portion of the receiving opening. This solution in particular is distinguished by high strength, without the installation flexibility being restricted further. To this end, the rotation-inhibiting sections are preferably at least partially parallel to the installation direction.

Further expedient developments can be gathered from further dependent claims and from the description.

### DRAWING

One exemplary embodiment of the fastening device for a cable according to the invention is illustrated in the drawing and will be explained in greater detail below.

In the drawing:

FIG. 1 shows a perspective view of the fastening device with a cable in the receiving opening,

FIG. 2 shows a sectional illustration perpendicular to the cable axis along the receiving opening,

FIG. 3 shows a sectional illustration along the longitudinal axis of the cable,

FIG. 4 shows a perspective view of the fastening device from the left,

FIG. 5 shows a perspective view of the fastening device from the right,

FIG. 6 shows a first side view of the fastening device,

FIG. 7 shows a second view of the fastening device,

FIG. 8 shows a sectional illustration along line A-A according to FIG. 7, and

FIG. 9 shows a sectional illustration along line B-B according to FIG. 7.

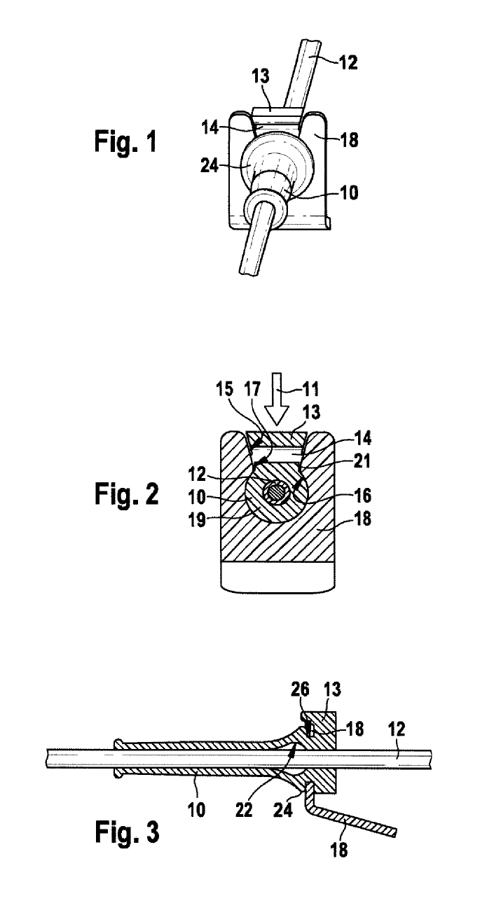

The fastening device for a cable 12 comprises a substantially rotationally symmetrical grommet 10. In the installed state, the grommet 10 is installed in a receiving opening 16 in a holder 18. Furthermore, the holder 18 has an installation opening 15 which is preferably oriented in a wedge-shaped manner and into which a guide part 13 of the grommet 10 is inserted in the installed state. The holder 18 has a substantially circular receiving opening 16 which opens into a constricted portion 17 toward the installation direction 11. The constricted area 17 has side edges which are oriented substantially parallel to the installation direction 11. Toward the outside, the constricted portion 17 ends in a preferably funnel-shaped installation opening 15 which widens outward starting from the constricted portion 17. The grommet 10 has, at that point at which it is arranged in the receiving opening 16, a circular section 19 in the lower region, said circular section having a groove-like contour 26 of reduced outside diameter. Rotation-inhibiting sections 21 are provided at the point where the grommet 10 interacts with the constricted portion of the holder 18. These sections are sections 21 which are not rotationally symmetrical—in relation to the cable axis as a possible axis of rotation—and which preferably have at least one side face which runs parallel to the installation direction 11. A recess 14 which is oriented substantially perpendicular to the installation direction 11 adjoins the rotation-inhibiting sections 21. Greater flexibility and mobility of the upper section of the guide part 13 relative to the rotationally symmetrical part of the grommet 10 are achieved as a result of this deliberate weakening of the material between the upper section of the guide part 13 and the rotationally symmetrical part of the grommet 10. Furthermore, the guide part 13 ends in the manner of a cone at the top, with the angle 20 of taper corresponding substantially to the opening angle of the installation opening 15.

The side view according to FIG. 3 shows that the guide part 13 projects beyond the groove-like contour 26 in the upper region.

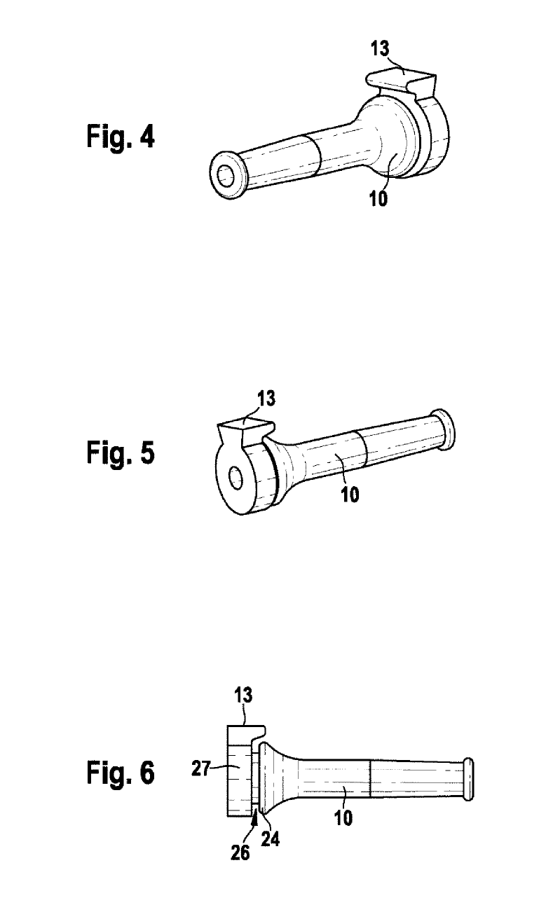

This is also shown in the views according to FIGS. 4 to 6.

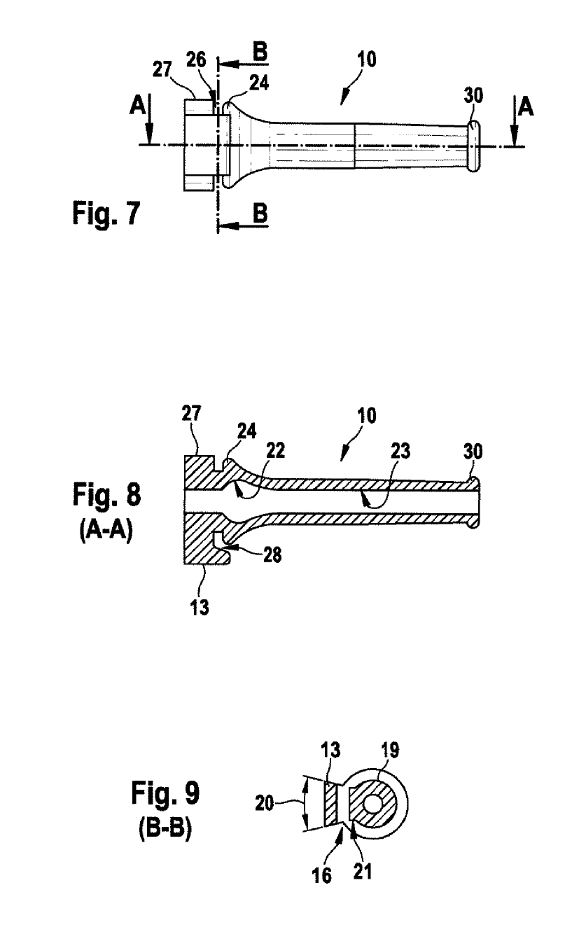

FIG. 7 once again shows the side view of the grommet in detail. It can be seen that a substantially cylindrical side wall 27 is provided, this side wall then merging with the groove-like contour 26 via an edge as the outside diameter reduces. A bead 24, of which the outside diameter is larger than that of the contour 26, adjoins the groove-like contour 26 which substantially has a cylindrical groove base. This bead 24 is provided with a certain radius and the diameter of said bead falls continuously, then has a constant outside diameter, while the outside diameter is once again reduced slightly in a last section. The grommet 10 ends in a front bead 30, the outside diameter of this front bead again being slightly increased in size.

The sectional illustration A-A according to FIG. 8 shows that the guide part 13 projects beyond the contour 26 and thus forms an undercut 28. In addition, a substantially cylindrical cable bushing 23 passes through the grommet 10 in the axial direction. The outside diameter of this cylindrical contour is widened just in front of the groove-like contour 26 to form a cavity 22. The cavity 22 between the grommet 10 and the cable 12 formed in this way is also highlighted once again in FIG. 3. The flexibility of the grommet 10 is thus increased since, as a result of the bead 24 being pressed for example, the position of the contour 26 is somewhat changed in order to make it easier to install the grommet 10 in the holder 18.

The sectional illustration B-B according to FIG. 9 once again shows that, in the region of the receiving opening 16, the grommet has a substantially circular section 19 which is interrupted by rotation-inhibiting, preferably parallel sections 21. The guide part 13 adjoins the rotation-inhibiting sections 21 by means of a deliberate weakening of the material, specifically a recess 14.

The grommet 10 is preferably composed of plastic and is molded directly onto the cable 12 by means of a plastics injection-molding process. In this case, the grommet 10 can be directly connected to the insulation of the cable 12 and thus sits permanently and immovably in a position on the cable 12 which is intended for the respective fastening function. In order to install the grommet 10, said grommet is inserted into the receiving opening 16 in the installation direction 11. The suitable material ensures that the grommet 10 can be deformed such that the contour 26 firstly enters the opening 16 but, on account of an elastic deformation process, the grommet 10 can sit in the holder 18 without play. For the purpose of installation in the correct position, the guide part 13 is equipped with a wedge-shaped section, with the angle 20, which interacts with a corresponding wedge-shaped installation opening 15. The elastic deformability of the grommet 10 is further assisted by the cavity 22 on which pressure can be exerted, and therefore the bead moves in the axial direction of the cable 12 in order to widen the contour 26, in particular at that point where the guide part 13 is arranged above the contour, and thus to make installation easier. Owing to the recess 14, the guide part 13 can also easily move to and fro in the axial direction of the cable 12 in order to thus likewise make installation even easier.

Other modifications, in particular in the geometry, are possible without having an adverse effect on the functionality of the grommet 10. For example, in particular, the guide edges of the guide part 13 do not necessarily have to be wedge-shaped; other geometries which serve for guidance purposes are possible. Furthermore, the shape of the recess 14 can vary since, for example, a plurality of recesses can be provided at different points. A person skilled in the art will provide said recesses particularly at points at which they are particularly beneficial for making installation easier. The rotation-inhibiting sections 21 do not have to be in the form of two parallel edges either; only one face which is not rotationally symmetrical could suffice.

The grommet 10 according to the invention is particularly suitable for installing cables 12 in a motor vehicle. However, other fields of application, which are not restricted to motor vehicles, are also possible.

1. A fastening device for a cable, comprising:
a holder defining a receiving opening,
a grommet configured to be clamped in the holder, so that the grommet surrounds the cable at least partially in the axial direction,
wherein the grommet is composed of an elastically deformable material which is detachably fastened in the receiving opening by way of a contour, and
wherein the grommet has (i) at least one guide part for installing the grommet in the receiving opening in the correct position, and (ii) a mechanism configured to increase the flexibility at least of the guide part.

2. The fastening device as claimed in claim 1, wherein the mechanism includes at least one recess oriented perpendicular to an installation direction.

3. The fastening device as claimed in claim 1, wherein the mechanism includes at least one cavity is formed between the grommet and the cable, said at least one cavity being configured to allow the grommet to move relative to the cable.

4. The fastening device as claimed in claim 1, wherein the guide part is at least partially wedge-shaped.

5. The fastening device as claimed in claim 1, wherein the grommet has a rotation-inhibiting section at least in the region of the contour.

6. The fastening device as claimed in claim 5, wherein the rotation-inhibiting section has a design which is not rotationally symmetrical in relation to the cable axis.

7. The fastening device as claimed in claim 1, wherein the contour is annular.

8. The fastening device as claimed in claim 1, wherein the guide part projects at least partially beyond the contour.

9. The fastening device as claimed in claim 1, wherein the guide part is connected to the grommet via at least one undercut.

10. The fastening device as claimed in claim 1, wherein the grommet has a side wall adjoining the contour.

11. The fastening device as claimed in claim 1, wherein the grommet has a bead adjoining the contour.

12. The fastening device as claimed in claim 11, wherein the outside diameter of the side wall is somewhat larger than the outside diameter of the bead.

13. The fastening device as claimed in claim 1, further comprising a front bead provided at one end of the grommet.

14. The fastening device as claimed in claim 11, wherein the transition between the contour and the bead is made at a certain radius.

15. The fastening device as claimed in claim 10, wherein the transition between the side wall and the contour is made via an edge.
